(19) United States
(12) Patent Application Publication
(10) Pub. No.: US 2009/0003295 A1
(43) Pub. Date: Jan. 1, 2009

(54) AD-HOC NETWORK DEVICE WITH REDUCED DATA LOSS

(75) Inventors: Tadashige Iwao, Kawasaki (JP); Takeshi Hosokawa, Kawasaki (JP); Koji Namura, Kawasaki (JP); Kenji Yamada, Fukuoka (JP); Nobuo Tougesaka, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/044,519

(22) Filed: Mar. 7, 2008

Related U.S. Application Data
(63) Continuation of application No. PCT/JP2005/016665, filed on Sep. 9, 2005.

(51) Int. Cl. H04Q 7/24

(52) U.S. Cl. 370/338

(57) ABSTRACT

When data is to be transmitted from a transmission source to a transmission destination in a wireless or wired ad-hoc network constructed in an indoor environment such as a house or an office, the data is transmitted by using a path that is formed over a plurality of channels that the respective nodes have. Also, when data transmission with high reliability is to be performed, same data is sent to two or more paths, thereby even when the data on one path cannot be normally delivered due to noise, the data can be delivered to the transmission destination without being affected by the noise by using the data transmitted on another channel.

### CROSS-REFERENCE TO RELATED APPLICATION

This application is a continuation application of the international patent application No. PCT/JP2005/016665, filed on Sep. 9, 2005.

### BACKGROUND OF THE INVENTION

1. Field of the Invention

The present invention relates to ad-hoc network devices that are arranged in houses or offices.

2. Description of the Related Art

In recent years, techniques have been developed, in which a network such as a wireless LAN or the like is constructed in houses or offices by connecting devices in a wired manner or in a wireless manner in order to improve the convenience of electronic devices. In this document, “ad-hoc network” refers not only to an indoor wireless ad-hoc network, but also to a wired network having the same functions.

Conventionally, it is said that many wireless network devices employ the spread spectrum method, in which digital signals are spread over a wide band, thereby even when noise is caused during communication, the noise does not greatly affect the communication because the noise is spread when the data is demodulated. However, in actual networks, there are various noise sources that exist continuously, which causes data losses.

For example, electromagnetic waves that a microwave oven generates in a room serve as a noise source in the wireless ad-hoc network. Also, in some cases, communication is interfered by electric noise in the wired ad-hoc network too.

There is a technique that aims at the reduction of data loss caused by noise in wireless networks by multiplexing antennas both in the transmitting and receiving sides. However, an effect of reducing the continuous-in-time noise over the frequency band that is the same as that used for the communication cannot be expected.

Therefore, at present, there is no technique by which the data loss can be reduced when there is a noise source that exists continuously in time in the real space.

Also, wired networks present greater resistance to noise than wireless networks do, however, wired networks do not have a countermeasure against electric noise. Also, in wired networks, traffic tends to concentrate on one path, which causes data loss, and there is no countermeasure against this convergence.

When the above data loss occurs frequently in the transmission and reception of data such as a video stream, block noise is caused in the images by the data loss or instantaneous interruptions occur when reproducing the audio information, which spoils the data.

### SUMMARY OF THE INVENTION

It is an object of the present invention to provide a network device that can compensate for the influence of data loss caused by various noise sources continuously existing in time in the real space or by the concentration of traffic, and can construct an ad-hoc network that realizes the stability and high quality of data transmission and reception.

The network device according to the present invention is a network device used in a network constructed by connecting a plurality of network devices by using wireless or wired channels, comprising:

a transmission/reception unit transmitting and receiving data by using a plurality of channels;

a path forming unit forming, over a plurality of channels, a transmission path used for transmitting data from a transmission source to a transmission destination; and

a control unit controlling a manner of sending data from the transmission/reception unit using the formed path, wherein:

the network including the network devices is an ad-hoc network or a wired network that forms an ad-hoc network, constructed in an indoor environment.

### BRIEF DESCRIPTION OF THE DRAWINGS

FIGS. 1A and 1B schematically show an outline of a wireless ad-hoc network in an embodiment of the present invention;

FIG. 2 schematically shows an outline of a wired ad-hoc network in an embodiment of the present invention;

FIG. 3 shows a routing model according to the present embodiment used when a plurality of links are established;

FIG. 4 shows a function relationship among a path search, data transfer, and link confirmation according to an embodiment of the present invention;

FIG. 5 shows a format of a message frame that is exchanged between nodes;

FIGS. 6A and 6B explain data transfer;

FIGS. 7A and 7B explain a flow for a route finding request process performed when the path search and the data transfer shown in FIG. 4 are performed;

FIGS. 8A through 8C explain a flow for a route finding response process performed when the path search and the data transfer in FIG. 4 are performed;

FIG. 9 explains operations of link confirmation processes; and

FIG. 10 explains a data transfer method according to an embodiment of the present invention, in which priority is given to reliability and the data loss is reduced.

### DESCRIPTION OF THE PREFERRED EMBODIMENTS

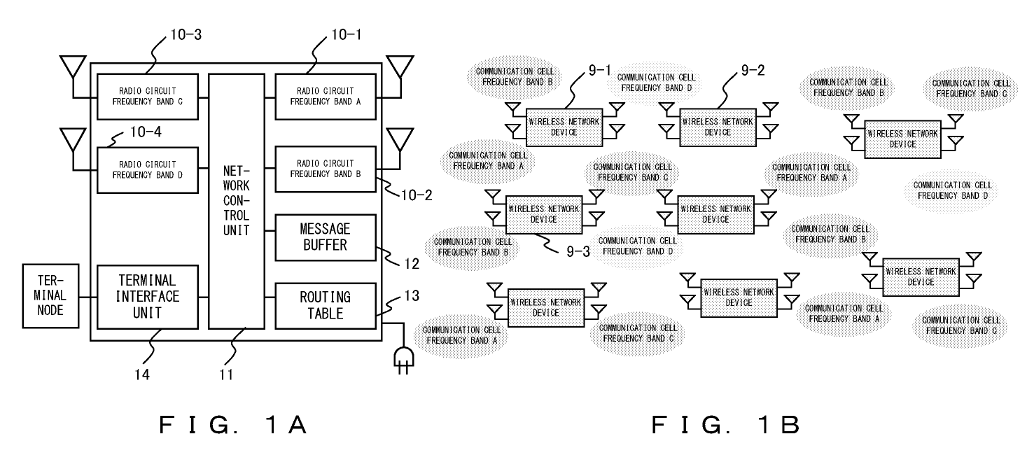

FIGS. 1A and 1B schematically show an outline of a wireless ad-hoc network in an embodiment of the present invention.

As shown in FIG. 1A, each wireless network device has a plurality of radio circuits 10-1 through 10-4 having different frequencies, a network control unit 11, a message buffer 12, a routing table 13, and a terminal interface unit 14. In FIG. 1A, each wireless network device can perform communication using four different frequency bands. Also, data that has been received via a wireless channel is temporarily stored in the message buffer 12. Then, the routing table 13 is referred to, and the received data is transmitted to another wireless network device. The terminal interface unit 14 serves as an interface or the like for Ethernet (registered trademark), and is used for the connection with a terminal node such as a personal computer or the like.

As shown in FIG. 1B, the connections between the adjacent wireless network devices are established by a plurality of communication links in the communication cells having different frequency bands under the autonomous routing control. In FIG. 1B, the wireless network devices that are adjacent to each other communicate with each other via the communication cell shown between them. For example, the wireless network device 9-1 and the wireless network device 9-2 communicate with each other by using the communication cell having the frequency band D. The wireless network devices 9-1 and 9-3 communicate with each other by using the communication cell having the frequency band A.

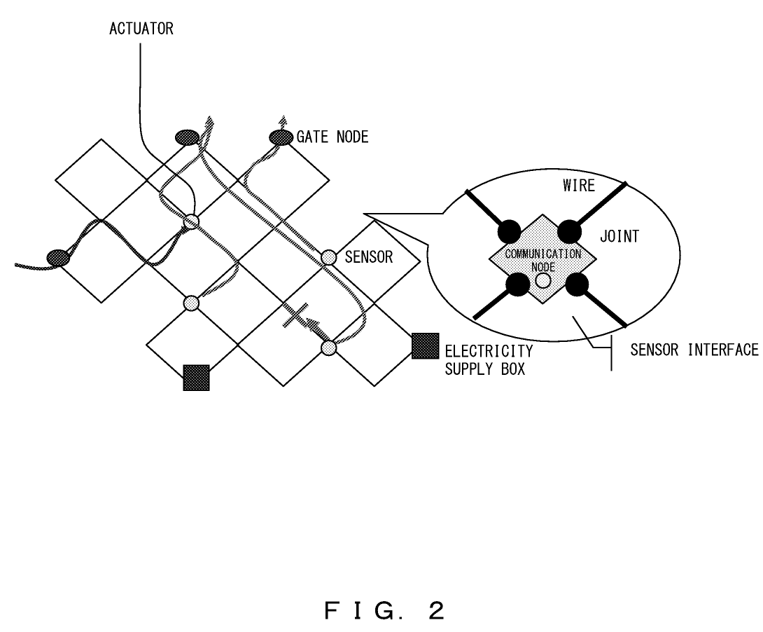

FIG. 2 schematically shows an outline of a wired ad-hoc network according to an embodiment of the present invention.

In FIG. 2, a wired communication network is constructed in such a manner that the constructed network forms a mesh for providing electricity and performing communication. In the nodes, gates, actuators, electricity supply boxes are provided. In each node, a communication node is provided, and the communication node has a joint for accepting a wire for the wired network and has a sensor interface to which a sensor is to be attached.

Also in this type of network, the data loss is caused by electric noise or concentration of traffic.

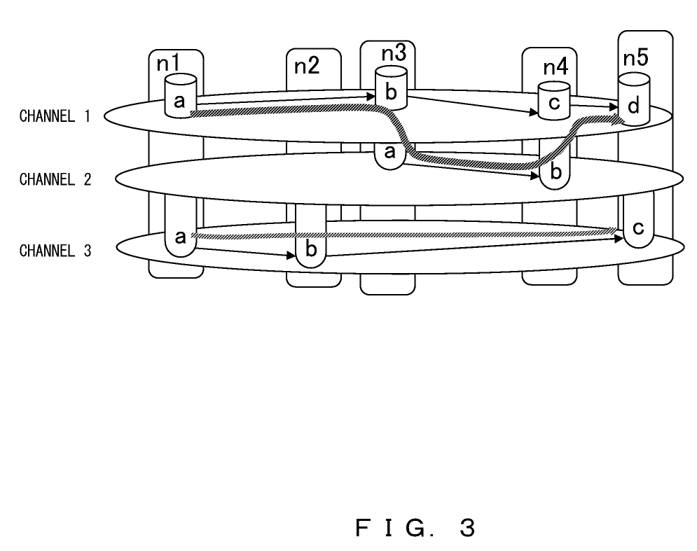

FIG. 3 shows a routing model according to the present embodiment used when a plurality of links are established.

Hereinafter, the wireless network is mainly used for the explanation, however, all of the explanations can be applied also to the wired network.

The plurality of links established among the respective wireless network devices are stored in routing tables in the respective wireless network devices as routing paths over one or two channels. The network control unit determines each transfer to be data transfer in which priority is given to performance or to a data transfer in which reliability is important, on the basis of the data type input from the terminal interface unit. Thereafter, the data is transferred by using a suitable channel on the basis of the routing table. For example, in the case of the data transfer in which reliability is important, the same data is transmitted on a plurality of channels so that even when one of the channels fails to transmit the data normally due to a noise source or the like, the receiving side can normally receive the data transmitted on other channels. Also, when the respective channels are different among one another in the transmission speed or quality, the Ack response time is periodically confirmed so that a suitable route to the destination can be added to the routing table.

An example of contents of the routing table is {Target node←(node:channel:address . . . )← . . . }

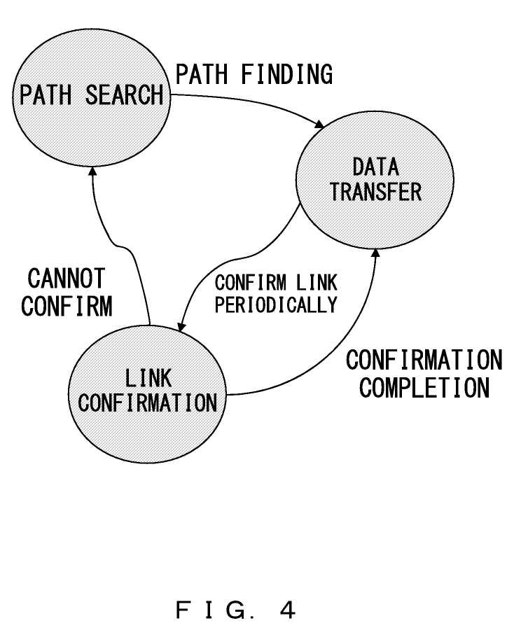

FIG. 4 shows the function relationship among the path search, the data transfer, and the link confirmation according to an embodiment of the present invention.

The path search is performed by issuing, transferring, responding to a search message, and by the registering the message in the routing table. When the path to the destination node is found by the path search, a link is established to this path, and data is transferred. While transferring the data, it is periodically confirmed whether link is not lost by noise or the like. When this confirmation of link is completed, the data transfer is continued. When the existence of the link cannot be confirmed in the confirmation of link, a search is performed for a path that can be used for establishing another link.

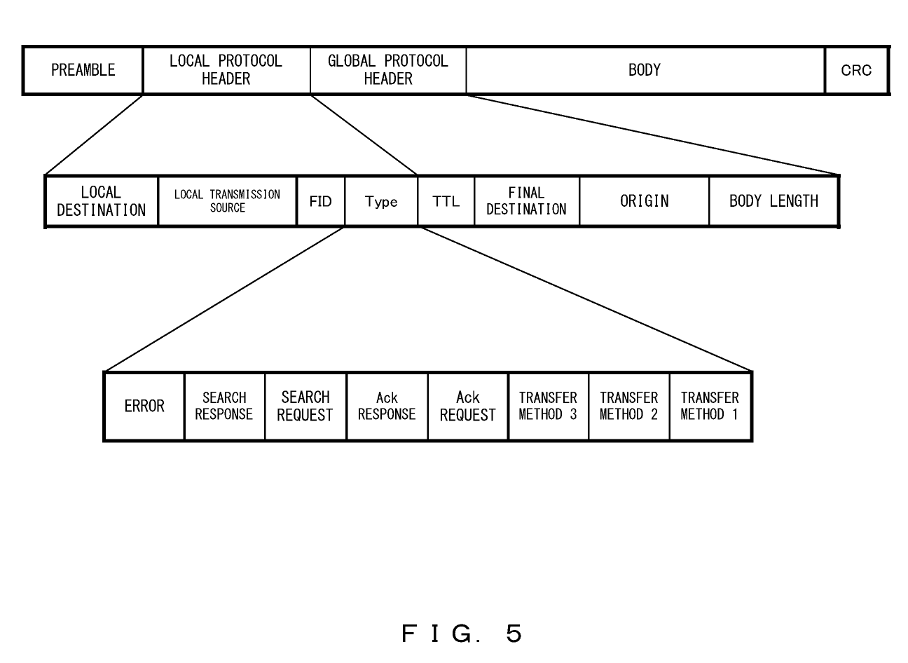

FIG. 5 shows the format of a message frame that is exchanged between nodes.

Each node has its unique number (ID). These IDs are used for the communication between the nodes. The preamble is a signal for establishing the wireless communication. The local protocol header is used for communications between two wireless network devices. The global protocol header is used for communications between the transmission sources and the transmission destinations. The body is a region in which data is stored. The CRC is a symbol used for the error correction. The local destination is the transmission destination on the path connecting the two adjacent wireless communication network devices. The local transmission source is the transmission source on the path connecting the two adjacent wireless communication network devices. The FID is an identification number assigned to a frame. The frames having the same FID hold the same data. The TTL is a counter value that is decremented each time the frame is transmitted through one hop. The final destination is the destination of the data. The origin is the transmission source of the data. The body length is the length of the body. The error included in the type portion is a bit that is set when there is no link. The search response, the search request, the Ack response, the transfer methods 3, 2, and 1 respectively represent the bits of the types of the message frames, and when one of the these bits corresponds to the type of the current frame, that bit is set.

The process of issuing the search messages is performed when the routing table does not include the final destination to which the message is to be transmitted. However, if a particular time t (t is a prescribed value that is to be set appropriately) has not elapsed from the moment of the previous broadcast, this message is not issued.

When the process of transferring the search message is performed, all the search messages except for the message for the device itself that is performing this process are transferred. However, the messages from the same transmission address are discarded. Also, for the transfer, a tag of the device itself is added to the messages and all the channels that the device has are used for transferring the message.

The device responses only to the search messages for that device itself. However, when the device has received the greater number of search messages than a prescribed number, the search messages are discarded.

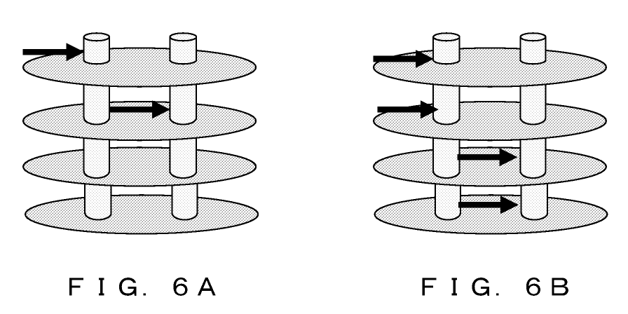

FIGS. 6A and 6B explain the data transfer.

In the data transfer process, a node takes in data only when the transmission destination of that data is that node, and when the transmission destination is not that node, the transfer process varies depending on the transfer method. When the transfer method is a method in which priority is given to performance, the transmission partner is retrieved from the routing table and sends the data from the channel that is other than the channel used for the reception as shown in FIG. 6A (round robin method). When the transmission method is a method in which priority is given to reliability, the transmission partner is retrieved from the routing table and the data is output from two or more channel interfaces that are other than the channel used for the reception as shown in FIG. 6B. When there is no node tag that corresponds to the routing table, a non-arrival error is returned to the transmission source.

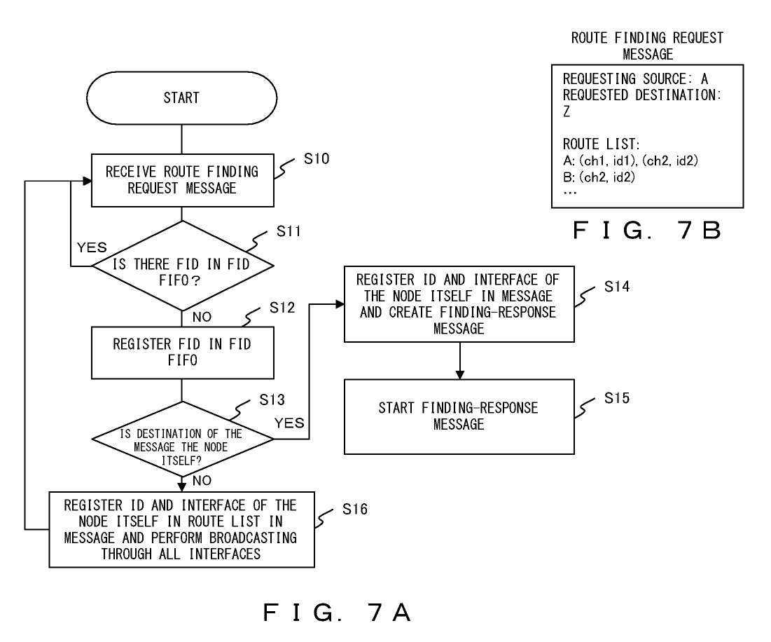

FIGS. 7A and 7B explain a flow for a route finding request process performed when the path search and the data transfer shown in FIG. 4 are performed.

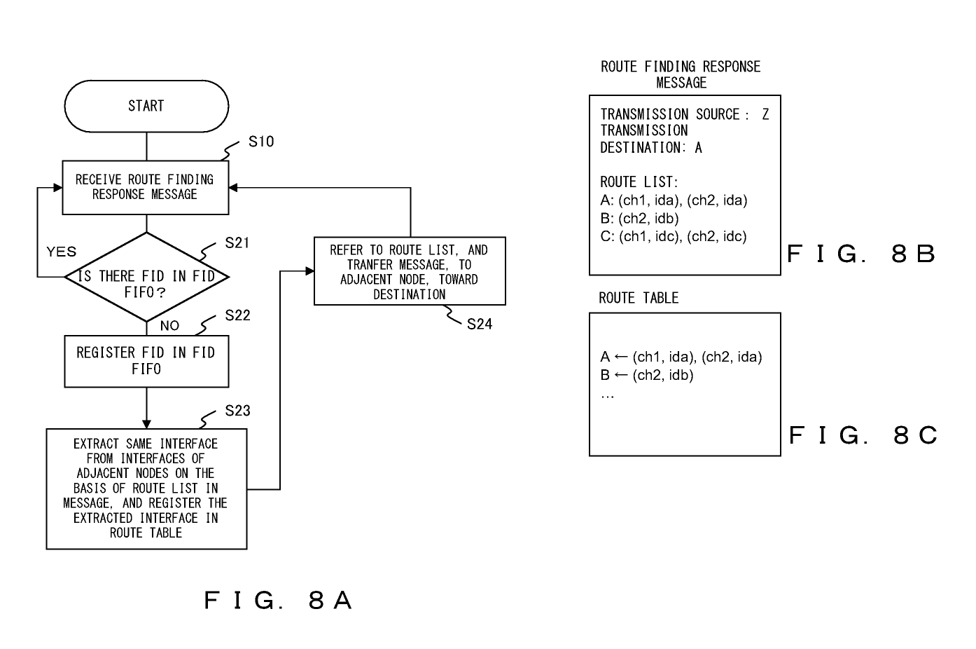

First, as shown in FIG. 7A, a route finding request message is received in step S10. In step S11, it is determined whether or not there is the FID (explained in FIG. 5) that is the same as that of this message in the FID FIFO. When the determination result in step S11 is Yes, the process proceeds to step S10. When the determination result in step S11 is No, that FID is registered in the FID FIFO in step S12. In step S13, the node determines whether the destination of the message is the node itself or other nodes. When the determination result in step S13 is No, the ID and the interface of the node itself are registered in the route list of the message in step S16, and data is broadcasted through all the interfaces. Thereafter, the process returns to step S10. When the determination result in step S13 is Yes, the ID and the interface of the node itself are registered in the message, and a finding-response message is created in step S14. Then, in step S15, the finding-response message process shown in FIGS. 8A and 8B is started.

As shown in FIG. 7B, the route finding request message includes the ID of the requesting source, the ID of the requested destination, and the route list that is added in step S16 on an as-needed-basis.

FIGS. 8A through 8C explain a flow for the route finding response process performed when the path search and the data transference in FIG. 4 are performed.

First, as shown in FIG. 8A, the route finding response message is received in step S20. In step S21, it is determined whether or not there is the FID that is the same as that of this received message in the FID FIFO. When the determination result in step S21 is Yes, the process returns to step S20. When the determination result in step S21 is No, the process proceeds to step S22. In step S22, that FID is registered in the FID FIFO. In step S23, the same interface is extracted from the interfaces of the adjacent nodes on the basis of the route list in the message, and the extracted interface is registered in the route table. Then, in step S24, the route list is referred to, and the message to the destination is transferred to the adjacent node. Thereafter, the process returns to step S20.

The route finding response message shown in FIG. 8B includes the ID of the transmission destination, the ID of the transmission source, and the route list. The route table shown in FIG. 8C is created by extracting the route list in the route finding response message shown in FIG. 8B.

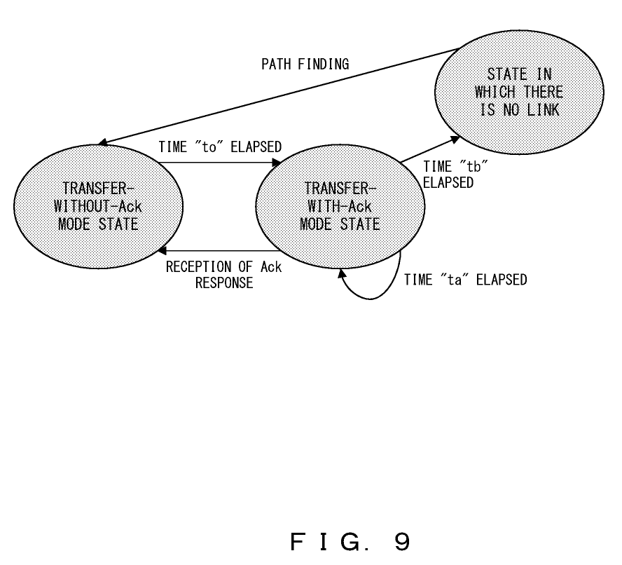

FIG. 9 explains the operations of link confirmation processes.

Immediately after the activation of a node, a link is established by the path search process in a state in which there is no link, and the state transits to a transfer-without-Ack mode. When a message is not received during the time “to” in the transfer-without-Ack mode, the mode transits to a transfer-with-Ack mode. While doing this, even when a message without the Ack response flag is received, it is assumed to be the Ack, and the transfer-without-Ack mode starts.

In the transfer-with-Ack mode, a message with Ack is transferred for each time when the time “ta” has elapsed. During this, when a message with the Ack response is received, the mode transits to the transfer-with-Ack mode. When there is no Ack response during the time “tb”, the mode transits to the state without a link, and the invalidation flags are set at the corresponding node tags (nodeid, channel, and address) on the routing table. When the invalidation flags are set at all the node tags in the target node, the link is disconnected.

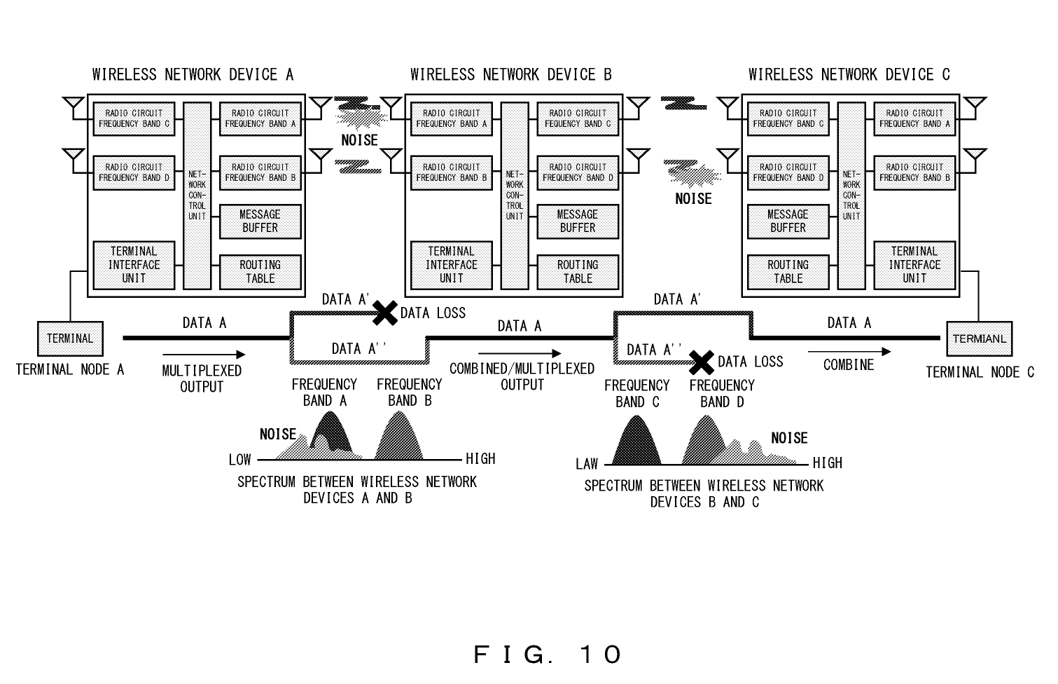

FIG. 10 explains the data transfer method in accordance with an embodiment of the present invention, in which priority is given to reliability and the data loss is reduced.

When data A is transferred from a terminal node A connected to a wireless network device A to a terminal node C connected to a wireless network device C, the data A input through the terminal node A includes the destination (i.e., the terminal node C), and this data A is output to the terminal interface of the destination wireless network device via a plurality of wireless network devices.

When the data A has been input through the terminal interface unit of the wireless network device A, data A′ and data A″ are output to a plurality of radio circuits as the multiplexed data having the same contents. This output is performed on the basis of the routing table of the reliability mode. The wireless network device B can restore data if the data loss was due to noise in one of the two pieces of data A′ and A″, by combining these two pieces of data when storing in the message buffer. By repeating the multiplexed output, combination, and restoration similarly between the wireless network devices that perform the multi-hop relay, it is possible to output data to the terminal node C of the destination wireless network device C in the data transfer method in which the reliability is high and the data loss is reduced.

Such data transfer, in which the reliability is high is advantageous when performing the video streaming or the like in ad-hoc networks because in the vide streaming, if data is lost, the block noise is caused in images or instantaneous interruptions occur when reproducing audio information while data is being reproduced in real time on the receiver side. By employing the technique disclosed in the embodiments of the present invention, this sort of data can be delivered to receiver sides while maintaining the quality of the data.

In the above explanations, a wireless network has been used. However, these explanations can be applied also to wired networks. In the case when the network device is a wireless network, a transmission/reception device that can transmit data using a plurality of frequency bands is included. Also, the present invention can be applied to a wired network device if the wired network device has a plurality of wire bounds or has a plurality of logical channels even when it has only one wire bound.

What is claimed is:

1. A network device used in a network constructed by connecting a plurality of network devices by using wireless or wired channels, comprising:
a transmission/reception unit for transmitting and receiving data by using a plurality of channels;
a path forming unit for forming, over a plurality of channels, a transmission path used for transmitting data from a transmission source to a transmission destination; and
a control unit for controlling a manner of sending data from the transmission/reception unit using the formed path, wherein:
the network including the network devices is an ad-hoc network or a wired network that forms an ad-hoc network, constructed in an indoor environment.

2. The network device according to claim 1, wherein:
the control unit controls the transmission/reception unit so that the transmission/reception unit sends same data to a plurality of paths when performing data transfer with high reliability.

3. The network device according to claim 1, wherein:
the transmission/reception unit is a wireless device that can transmit and receive data by using a plurality of frequency bands.

4. The network device according to claim 1, wherein:
the network including the network devices transfers video streaming data.

5. The network device according to claim 1, wherein:
the path forming unit sends, to a network, a message for searching for a path from a transmission source to a transmission destination, and receives information on a path, said information being written in the message by each network device, and thereby finds a path that can be formed.

6. The network device according to claim 5, wherein:
an identifier for identifying a content of the message is added to the message; and
when there are messages having the same identifiers in one network device, only one message is retained and the other messages having the same identifiers are discarded.

7. The network device according to claim 1, wherein:
the path forming unit periodically checks whether or not the formed path has existed.

8. The network device according to claim 7, wherein:
the path forming unit sends to another network device, continuously for a prescribed period, a message for finding a path when checking existence of a path.

9. The network device according to claim 7, wherein:
the path forming unit determines that a path has been lost if a message in response to a message for finding a path does not reach the path forming unit from another network device within a prescribed time when checking existence of a path.

10. A method of transferring data in a network constructed by connecting a plurality of network devices by using wireless or wired channels, comprising:
providing a transmission/reception unit transmitting and receiving data by using a plurality of channels;
forming, over a plurality of channels, a transmission path used for transmitting data from a transmission source to a transmission destination; and
controlling a manner of sending data from the transmission/reception unit using the formed path, wherein:
the network is an ad-hoc network or a wired network that forms an ad-hoc network, constructed in an indoor environment.
